(19) United States
(12) Patent Application Publication
(10) Pub. No.: US 2007/0124319 A1
(43) Pub. Date: May 31, 2007

(54) Metadata generation for rich media

(75) Inventors: John C. Platt, Redmond, WA (US); M. Michael Robinson, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/287,982

(22) Filed: Nov. 28, 2005

(51) Int. Cl. G06F 7/00

(52) U.S. Cl. 707/101

(57) ABSTRACT

Metadata is generated for rich media content from a document or workflow that is associated with the rich media content. When rich media content is included in a document or workflow, text is extracted from the document or workflow that is relevant to the rich media content. The text is filtered into keyphrases and added to a metadata file associated with the rich media content.

### BACKGROUND

Media is a term that takes on multiple meanings depending on the context in which it is used. Narrowing the term to electronic media still provides a number of definitions for the term. One type of electronic media refers to rich media or rich content media. Rich media refers to sound files, video files, images, photos, 3D models, and other types of rich content that may be stored on a computer or obtained over a network. Multimedia may be a combination of these types of media.

Rich media, especially photos and images, are often difficult to search for and find either in a database or over a network. These types of media generally lack any “natural” metadata that allows a search engine or other search program to locate a specific media file. Metadata refers to data that is about data. Stated differently, metadata may describe how and when and by whom a particular set of data was collected, and how the data is formatted. Additionally, metadata may be used to uniquely identify a file or other type of stored data so that it may be located. Metadata has been found to be essential for understanding information stored in data warehouses and has become increasingly important in XML-based Web applications.

One solution for solving the lack of metadata associated with rich media has been to require that a user storing the media in a database or placing the metadata on a network manually enter the metadata for the rich media. This solution can be painful and costly when the amount of media reaches any significant level. The solution also goes against the freeform creative process and is considered a substantial burden on the creators of the media. It is also costly if librarians or other administrators of the media must painstakingly catalogue each media file, especially when those files number in the millions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Metadata is automatically associated with a rich media file as the media file is the subject of workflow. Creating automatic metadata for rich media helps users identify files in the future with ease, and without painstakingly adding the metadata by hand. From the workflow, contextual keywords may be discovered that are used when the file is created, approved, stored and used. A Digital Asset Management (DAM) system may be used to capture the contextual keyphrases from the workflow processes. For example, the rich media may be used or embedded into a presentation, spreadsheet, word processor document, or the like. Contextual keyphrases may be located within proximity of the media in the document in which the media is embedded. These keyphrases may then be added as metadata to the media file. Another common example is when a rich media file sent in a message, such as in an e-mail message. The e-mail may provide context or a description of the rich media for the recipient. This descriptive content is captured and added to the metadata of the media file.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing architecture for a computer;

FIGS. 2-4 illustrate overviews of systems for automatically generating metadata for rich media from a workflow or document; and

FIG. 5 displays an exemplary operational flow for generating metadata for rich media, in accordance with aspects of the present invention.

### DETAILED DESCRIPTION

Embodiments of the present invention are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments of the present invention may be practiced as methods, systems or devices. Accordingly, embodiments of the present invention may take the form of an entirely hardware implementation, an entirely software implementation or an implementation combining software and hardware aspects. The following detailed description is, therefore, not to be taken in a limiting sense.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

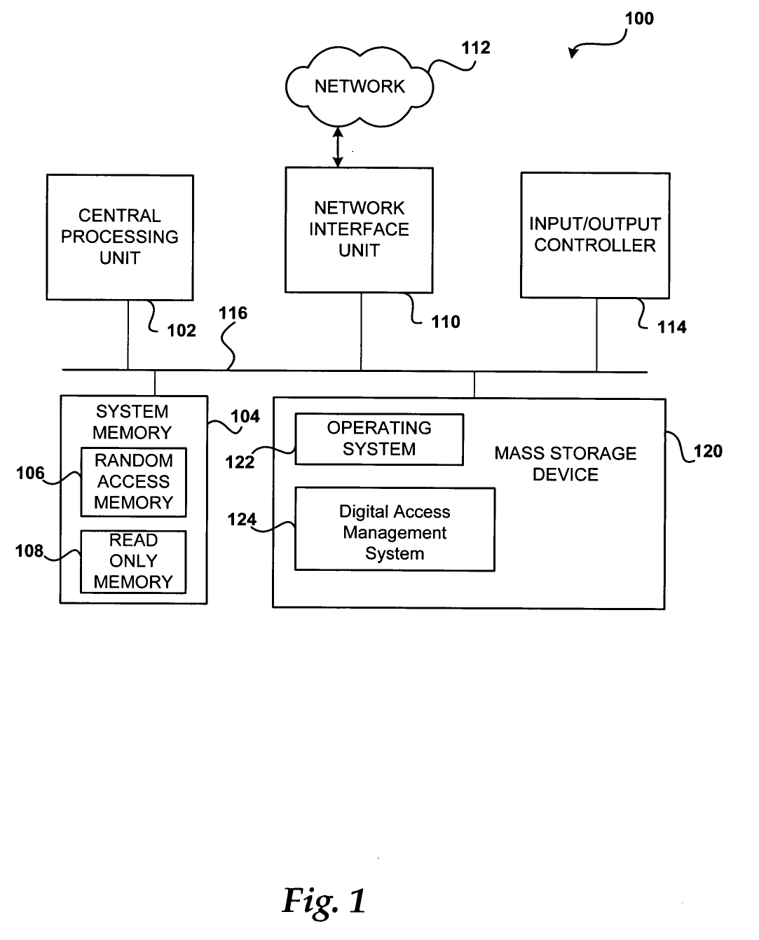

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an exemplary computer architecture for a computer 100 utilized in various embodiments will be described. The computer architecture shown in FIG. 1 may be configured in many different ways. For example, the computer may be configured as a server, a personal computer, a mobile computer and the like. As shown, computer 100 includes a central processing unit 102 (“CPU”), a system memory 104, including a random access memory 106 (“RAM”) and a read-only memory (“ROM”) 108, and a system bus 116 that couples the memory to the CPU 102. A basic input/output system containing the basic routines that help to transfer information between elements within the computer, such as during startup, is stored in the ROM 108. The computer 100 further includes a mass storage device 120 for storing an operating system 122, application programs, and other program modules, which will be described in greater detail below.

The mass storage device 120 is connected to the CPU 102 through a mass storage controller (not shown) connected to the bus 116. The mass storage device 120 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, the computer 100 operates in a networked environment using logical connections to remote computers through a network 112, such as the Internet. The computer 100 may connect to the network 112 through a network interface unit 110 connected to the bus 116. The network interface unit 110 may also be utilized to connect to other types of networks and remote computer systems.

The computer 100 may also include an input/output controller 114 for receiving and processing input from a number of devices, such as: a keyboard, mouse, electronic stylus and the like. Similarly, the input/output controller 114 may provide output to a display screen, a printer, or some other type of device (not shown).

As mentioned briefly above, a number of program modules and data files may be stored in the mass storage device 120 and RAM 106 of the computer 100, including an operating system 122 suitable for controlling the operation of a networked computer, such as: the WINDOWS XP operating system from MICROSOFT CORPORATION; UNIX; LINUX and the like. The mass storage device 120 and RAM 106 may also store one or more program modules. In particular, the mass storage device 120 and the RAM 106 may store a digital asset management system 124.

As presented herein, digital asset management system 124 includes functionality for capturing contextual keyphrases from media files used within workflows, documents, or applications. Many documents include text that may be associated with media in close proximity to the text. These text blocks, with a relative weighting of importance, may provide keyphrases that are associated with the media. Digital access management system 124 may then add these keyphrases to the metadata of the media, so that the media can be identified and located through a search that identifies the keyphrases.

Throughout the specification and claims, the following terms take the meanings explicitly associated herein, unless the context clearly dictates otherwise.

“Document” is generally defined as any page, sheet, form, or other construction of an application that comprises text, graphical objects, tables, data cells, or other types of data representations. Examples of documents include word processor documents, spreadsheets, charts, slides, web pages, worksheets, notes, e-mail messages, instant messages, drawings, schematics, images, and other arrangements of text and/or graphical objects.

“Keyphrase” generally refers to one or more words that may be found to be meaningful for search purposes. A one, two, three, or more word phrase may be considered a keyphrase. The definition for a keyphrase encompasses the more common term of “keyword” as well as other text constructs that comprise more than a single word.

“Metadata” generally refers to data that is about data. Metadata may include workflow information that describes how and when and by whom a particular set of data was collected, and how the data is formatted. Additionally, metadata may be used to uniquely identify a file or other type of stored data so that it may be located. Metadata may include keyphrases from documents in which the file to which the metadata applies is embedded.

“Media” or “Rich Media” is generally defined as sound files, video files, images, photos, 3D models, graphics, animations, and other types of rich content that may be stored on a computer or obtained over a network. This definition also encompasses the various types of multimedia which represent a combination of these types of media.

“Workflow” is generally defined as the operational aspect of a work procedure: how tasks are structured, who performs them, what their relative order is, how they are synchronized, how information flows to support the tasks and how tasks are being tracked. All of the information of a workflow may be considered relevant information for metadata of a rich media file.

Embodiments herein describe automatically generating metadata for rich media from a workflow/document associated with the media. For example, consider an image of the main island of Hawaii sent over e-mail where the email states in the subject line “picture of Hawaii”. One embodiment described herein extracts the term “Hawaii” from the e-mail subject line and places it in the metadata file associated with the image. Accordingly, when a search is later made for images of Hawaii, this particular image is returned as one of the results because of the metadata automatically added to its metadata file.

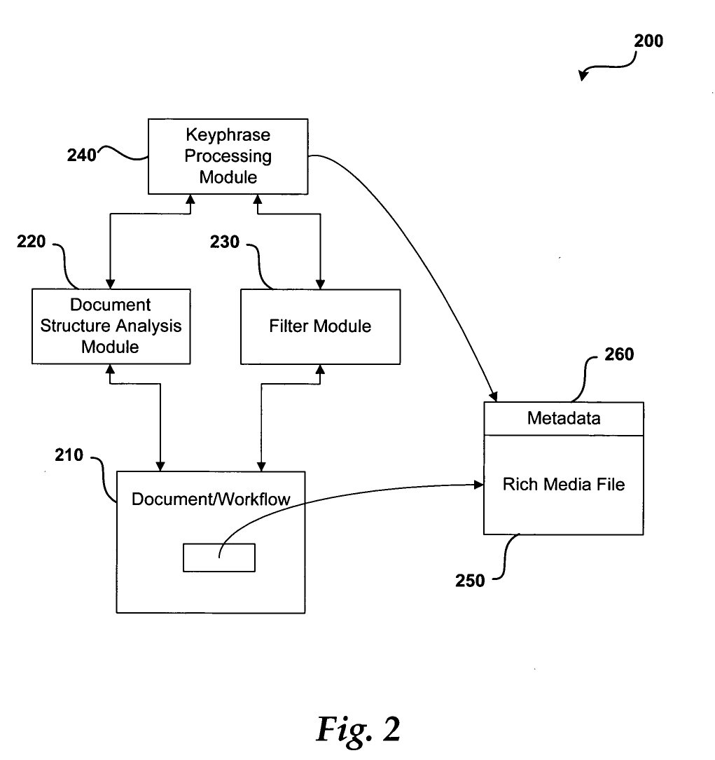

FIG. 2 illustrates a first overview of a first system for automatically generating metadata for rich media from a workflow or document, in accordance with aspects of the invention. In one embodiment, system 200 corresponds to the digital access managements system 124 shown in FIG. 1. System 200 includes a document or workflow 210, an document structure analysis module 220 and/or filter module 230, keyphrase processing module 240, rich media file 250, and metadata 260. Media file 250 is shown as being included or embedded in document or workflow 210, however the media file may be associated with the document or workflow without being actually included. For example, a document may include a link to an image without actually including the image.

An document structure analysis module 220 or a filter module 230 recognizes that the document or workflow 210 includes a rich media file 250. Document structure analysis module 220 operates to generate document object model (DOM) of an object or other construct for extracting text and text-related data from the document or workflow. An example of such a document structure analysis module would be the HTML parser inside of the INTERNET EXPLORER® network browser produced by the MICROSOFT® Corporation, accessible through its COM interface. Similarly, the filter module 230 operates to extract the text and text-related data from the document or workflow, and forwards the text and data to keyphrase processing module 240. An example of such a filter module would be components that implement the IFilter module in the MICROSOFT WINDOWS® operating system, such as the IFilter for documents produced by the MICROSOFT WORD® word processing application.

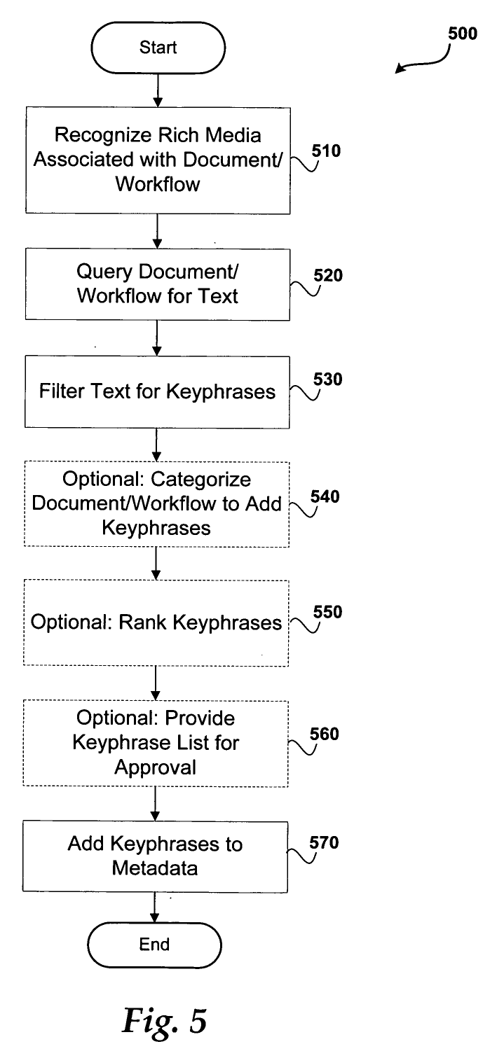

Keyphrase processing module 240 is arranged to determine the keyphrases that are contained within the text extracted from the document or workflow 210. In one embodiment, keyphrase processing module 240 determines the relevance of the keywords while filtering the text for the keywords. Keyphrase processing module 240 uses the text-related data, such a proximity measures of the text to the media, to further refine the relevance calculation of the keyphrases to the rich media file 250. Additional operations of the keyphrase processing module 240 are further described in the discussion of FIG. 5 below.

In system 200, once the keyphrases are determined for the media based on the current workflow or document 210, the keyphrases are provided to a metadata file 260 that is attached to rich media file 250. In this embodiment, as the rich media file 250 is transferred from one computer or database to another, the metadata 260 accompanies the rich media file 250. Accordingly, as the rich media file 250 is processed and included in various applications, the metadata 260 is updated to reflect the processing of the rich media file 250. Keyphrases are added to the metadata file 260 as the media file 250 is used in associated with new text content.

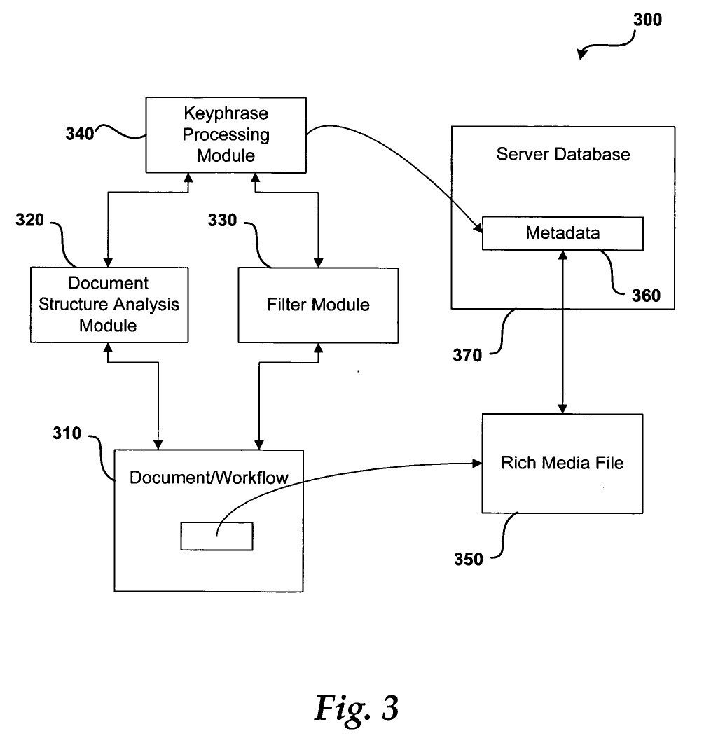

FIG. 3 illustrates a second overview of a second system for automatically generating metadata for rich media from a workflow or document, in accordance with aspects of the invention. In one embodiment, system 300 corresponds to the digital access management system 124 shown in FIG. 1. System 300 includes a document or workflow 310, an document structure analysis module 320 and/or filter module 330, keyphrase processing module 340, rich media file 350, and server database 370 which includes metadata file 360.

System 300 operates similar to system 200 shown in FIG. 2, however metadata file 360 is not attached to rich media file 350. Instead, metadata file 360 is maintained as part of server database 370 separate from rich media file 350. The separate server database 370 provides for increased privacy for the metadata. For example, a company may have a large database of proprietary images. The metadata is stored on a server database 370 internal to the company. The metadata allows an employee to search and sort media files, however, it may contain information that is considered private to the company (e.g., related upcoming products the image is associated with, etc.). Keeping the metadata in a separate server database 370 ensures that when an image is sent out external to the company, the metadata is not included with the image.

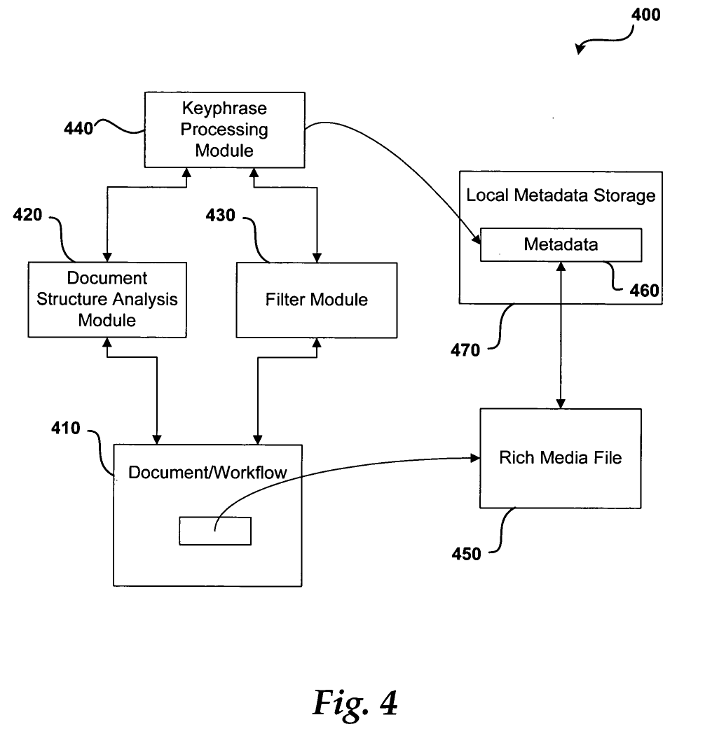

FIG. 4 illustrates a third overview of a third system for automatically generating metadata for rich media from a workflow or document, in accordance with aspects of the invention. In one embodiment, system 400 corresponds to the digital access management system 124 shown in FIG. 1. System 400 includes a document or workflow 410, an document structure analysis module 420 and/or filter module 430, keyphrase processing module 440, rich media file 450, and local metadata storage 470 which includes metadata file 460.

System 400 operates similar to system 300 and system 400 shown in FIGS. 2 and 3, however metadata file 460 is not attached to rich media file 350 nor stored in a server database 370. Instead, metadata file 360 is maintained as part of a local metadata storage 460 separate from rich media file 450. The local metadata storage 470 allows a user to associated metadata 460 with a rich media file 450 without sharing that metadata across a network. The metadata 460 does not travel with the rich media file 450 when the rich media file is transferred to across a network. The metadata 460 is also not shared with other entities on a local or other type of network.

Other system architectures are available different than those shown in FIGS. 2-4. As long as the metadata is associated with the rich media file, the storage location of the metadata is a decision that may be made according to other factors affecting the use of the rich media file.

FIG. 5 displays an exemplary operational flow for generating metadata for rich media, in accordance with aspects of the present invention. After a start block, the process flows to operation 510, where the digital access management system recognizes that a rich media item (such as an image) has been associated with a document or workflow. An image may be associated with any number of documents or workflows. In one embodiment, the digital access management system operates in the background and determines when an image is associated with an active document or workflow. In another embodiment, the digital access management system is invoked by a user to scan the documents and workflows stored on the user's computer to automatically generate metadata for the images associated with the documents and workflows. Although workflows have been referred to herein as an object, it is understood that workflows may be a series of objects associated with a specified set of actions. For example, a workflow may correspond to the actions of downloading, viewing, reviewing, and approving an image for use. Accordingly, when metadata is generated for a workflow, the viewers of the image, the reviewers, the approvers may all be included as metadata for the image. Additionally, folder or filename, where the image has been stored, may also be metadata produced from analyzing the workflow related to the image. Finally, any actions, such as whether an image was viewed, printed or downloaded may also be metadata created during the workflow.

The type of application from which text may be extracted for a rich media file is not limited to traditional documents. For example, users use email considerably during media workflow for collaborating, approval and querying. As users send these emails with the files attached, subject headings and email text may be used as keyphrase sources. To ensure privacy concerns, the sections of an e-mail to use as sources for keyphrases are selectable, allowing certain portions of the e-mail to be kept private. In another example, images and other media are often included in presentation slide decks. In a slide presentation, text keyphrases may be sourced from the slide title, the main title and/or from adjacent text boxes to the media. Other document file types may also be the source of contextual keyphrases.

Moving to operation 520, the document or workflow is queried for the text associated with the image. The text associated with the image may be determined as all the text of the document. Additionally, the text associated with the image may determined to be the text on the same page as the image. In an alternative embodiment, the document or workflow is directly queried for the keyphrases of the document or workflow. For example, the query may be to a document object model of the document. Using the document object model data, text that is within a selected proximity of the image may be extracted, or text that is in a specified position relative to the image, rather than extracting all the text from the document. The text that is selectively extracted based on these criteria is then assumed to correspond to keyphrases (once filtered) of the image due to its proximity or position.

Flowing to operation 530, the text extracted from the document or workflow is filtered for the keyphrases. Many extraneous words are present in random text, such as prepositions and conjunctions. These words are removed by the use of a stopword list or other filter mechanism. Also, poor keywords can be removed by checking the grammatical structure of the text. For example, nouns and noun phrases are often valuable keyphrases, while verbs and adjectives may not. Natural language processing algorithms are available that automatically extract nouns and noun phrases. In addition, natural language processing algorithms are available which find relevant keyphrases from documents. These algorithms may be used to filter the text for the keyphrases associated with the rich media. After the keyphrases are filtered from the text, processing may continue with optional operations 540, 550, or 560, or may instead move to operation 570 where the keyphrases are added to the metadata for the rich media.

Transitioning to optional operation 540, the document or workflow that contains the rich media may be categorized to extract further keyphrases associated with the rich media. The words and phrases that occur in associated documents may not cover the entire set of desirable keywords. For example, a document about geology may have words such as “volcano,” “lava,” “plate tectonics,” but never explicitly contain the word “geology.” In order to expand the vocabulary of the document, classification algorithms may be applied to the document. Such classification algorithms are known in the art: for example, see U.S. Pat. No. 6,192,560 to Dumais, et. al. A classification algorithm categorizes a document into a taxonomy. The label(s) produced by the classification algorithm may then be added to the list of keyphrases for the rich media.

Moving to optional operation 550, the keyphrases extracted from the document or workflow may be ranked according to their relevance to the rich media. Some keyphrases are more useful than others, and ranking the keyphrases accounts for the differences among the results. For example, a caption underneath a photo in a word processor document should generally be given a higher importance than other text on the page or even the title of the document. Also, the data from some document types might be more valuable sources than other document types (e.g., a word processor document vs. an e-mail). Furthermore, the importance of a keyphrase may be dependent on how the keyphrase was generated, as extracted text from the document, or as a label from a classification algorithm.

At optional operation 560, the generated keyphrase list may be provided to a user for approval. For example, as user may have placed an image in an e-mail and clicked “send”. The digital access management system had extracted keyphrases from the e-mail to be included in the metadata file attached to the image. Before the image is sent, a dialog or pop-up window appears and asks the user whether to add the keyphrases to the metadata file, allowing the user to delete or potentially add additional keyphrases to the image before transmission.

Continuing at operation 570, the finalized keyphrase list is provided to the metadata file of the rich media. Accordingly, these keyphrases are now associated with the rich media, such that when a search is initiated using one or more of the keyphrases, the rich media is returned as a search result. With the keyphrases added to the metadata of the rich media, the rich media may be identified and located among databases of media content.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for automatically associating metadata with rich media, comprising:
extracting text from at least one of a document and a workflow, wherein the text is extracted from the document when the document is associated with the rich media and the text is extracted from the workflow when the workflow is associated with the rich media;
processing the extracted text to identify keyphrases; and
associating the keyphrases as metadata for the rich media.

2. The computer-implemented method of claim 1, further comprising recognizing whether the rich media is associated with at least one of the document and the workflow when at least one of the document and the workflow is active.

3. The computer-implemented method of claim 2, further comprising querying at least one of the document and the workflow for text, wherein the document is queried for text when the document is associated with the rich media and the workflow is queried for text when the rich media is associated with the workflow.

4. The computer-implemented method of claim 1, wherein processing the extracted text further comprises filtering the extracted text to determine keyphrases included in the extracted text.

5. The computer-implemented method of claim 4, wherein filtering the extracted text comprises identifying the grammatical structure of the text and removing words based on their grammatical structure.

6. The computer-implemented method of claim 1, wherein processing the extracted text further comprises categorizing at least one of the document and the workflow according to a taxonomy, such that additional keyphrases are produced.

7. The computer-implemented method of claim 1, wherein processing the extracted text further comprises ranking the identified keyphrases according to relevance of the identified keyphrases to the rich media.

8. The computer-implemented method of claim 7, wherein relevance of the identified keyphrases to the rich media is determined by at least one of the following: proximity of a keyphrase to the rich media; type of document from which the keyphrase was extracted; whether the keyphrase was generated from categorizing at least one of the document and the workflow; and the position of the keyphrase relative to the rich media.

9. The computer-implemented method of claim 1, wherein processing the extracted text further comprises providing a list of the keyphrases identified from the extracted text to a user for approval.

10. The computer-implemented method of claim 1, wherein associating the keyphrases as metadata for the rich media attaches the keyphrases as metadata to the rich media.

11. The computer-implemented method of claim 1, wherein associating the keyphrases as metadata for the rich media stores the keyphrases as metadata in a server database.

12. The computer-implemented method of claim 1, wherein associating the keyphrases as metadata for the rich media stores the keyphrases as metadata in a local metadata store.

13. A computer-readable medium having stored thereon instructions that when executed implements the method of claim 1.

14. A computer-readable medium having computer-executable instructions for automatically associating metadata with a rich media file, comprising:
recognizing whether the rich media is associated with at least one of a document and a workflow when at least one of the document and the workflow is active;
querying at least one of the document and the workflow for text;
extracting text from at least one of the document and the workflow;
identifying keyphrases from amongst the extracted text; and
inserting the keyphrases into metadata that is associated with the rich media file.

15. The computer-readable medium of claim 14, wherein identifying keyphrases further comprises at least one of the following: categorizing at least one of the document and the workflow according to a taxonomy, such that additional keyphrases are produced; ranking the identified keyphrases according to relevance of the identified keyphrases to the rich media; and providing a list of the keyphrases identified from the extracted text to a user for approval.

16. The computer-readable medium of claim 15, wherein ranking the identified keyphrases further comprises determining the relevance of the identified keyphrases to the rich media according to at least one of the following: proximity of a keyphrase to the rich media; type of document from which the keyphrase was extracted; whether the keyphrase was generated from categorizing at least one of the document and the workflow; and the position of the keyphrase relative to the rich media.

17. The computer-readable medium of claim 14, wherein the metadata is stored in at least one of the following locations: the rich media file; a database server; and a local metadata store.

18. A system, comprising:
a rich media file included in at least one of a document and a workflow;
metadata associated with the rich media file;
a digital access management system associated with the rich media file and metadata that is configured to perform steps, comprising:
querying at least one of the document and the workflow for text;
extracting text from at least one of the document and the workflow;
filtering the extracted text for keyphrases;
processing the keyphrases to refine a list of keyphrases for addition to the metadata file; and
inserting the keyphrases into metadata that is associated with the rich media file, wherein the metadata is stored in at least one of the following locations: the rich media file; a database server; and a local metadata store.

19. The system of claim 18, wherein processing the keyphrases to refine a list of keyphrases further comprises at least one of the following: categorizing at least one of the document and the workflow according to a taxonomy, such that additional keyphrases are produced; ranking the identified keyphrases according to relevance of the identified keyphrases to the rich media; and providing a list of the keyphrases identified from the extracted text to a user for approval.

20. The system of claim 18, wherein filtering the extracted words for keyphrases further comprises at least one of the following: removing prepositions and conjunctions from the extracted text; and identifying nouns and noun phrases amongst the extracted text.
